(19) United States
(12) Patent Application Publication
(10) Pub. No.: US 2026/0097770 A1
(43) Pub. Date: Apr. 9, 2026

(54) ROAD SURFACE GRADIENT ESTIMATION DEVICE

(71) Applicants: TOYOTA JIDOSHA KABUSHIKI KAISHA, Toyota-shi (JP); J-QuAD DYNAMICS Inc., Tokyo (JP); ADVICS CO., LTD., KARIYA-SHI (JP)

(72) Inventors: Teruya YAMAGUCHI, Obu-shi (JP); Masayuki ASANO, Tokyo (JP)

(21) Appl. No.: 19/294,599

(22) Filed: Aug. 8, 2025

(30) Foreign Application Priority Data
Oct. 3, 2024 (JP) 2024-174148

(51) Int. Cl. B60W 40/076; B60W 30/02

(52) U.S. Cl. CPC B60W 40/076; B60W 30/02; B60W 2420/503; B60W 2520/105; B60W 2520/28; B60W 2530/10; B60W 2552/15

(57) ABSTRACT

A road surface gradient estimation device includes an acquisition unit that acquires each of detection results of an acceleration detection unit that detects an acceleration in a front-rear direction of a vehicle, and a wheel speed detection unit, and acquires information regarding power for driving the vehicle, a derivation unit that derives a gradient of a road surface on which the vehicle is traveling as a first road surface gradient based on the acquired acceleration and wheel speed, and a correction unit that corrects the derived first road surface gradient based on the information regarding the power for driving the vehicle to derive a second road surface gradient.

### CROSS-REFERENCE TO RELATED APPLICATION

This application claims priority to Japanese Patent Application No. 2024-174148 filed on Oct. 3, 2024. The disclosure of the above-identified application, including the specification, drawings, and claims, is incorporated by reference herein in its entirety.

### BACKGROUND

### 1. Technical Field

The present disclosure relates to a technology of estimating a gradient of a road surface on which a vehicle is traveling.

### 2. Description of Related Art

Japanese Unexamined Patent Application Publication No. 2018-054527 (JP 2018-054527 A) discloses a control device of a vehicle including a gradient estimation unit that estimates a gradient based on a front-rear acceleration sensor value and an acceleration obtained from a change amount of a wheel speed, and a change amount limitation unit that limits the change amount of the wheel speed based on a calculated acceleration of the vehicle in accordance with torque of a motor. This change amount limitation unit limits the change amount of the wheel speed when the wheel goes into a slide, and the gradient estimation unit estimates the gradient based on a change amount limit value.

### SUMMARY

In the technology disclosed in JP 2018-054527 A, when detection accuracy of an acceleration sensor always degrades in advance due to an offset error, or the like, there is a possibility that estimation accuracy of the gradient may degrade.

An object of the present disclosure is to provide a technology of preventing degradation of accuracy in deriving a gradient of a road surface on which a vehicle is traveling.

To solve the above-described problem, a road surface gradient estimation device according to one aspect of the present disclosure includes an acquisition unit that acquires each of detection results of an acceleration detection unit that detects an acceleration in a front-rear direction of a vehicle, and a wheel speed detection unit, and acquires information regarding power for driving the vehicle, a derivation unit that derives a gradient of a road surface on which the vehicle is traveling as a first road surface gradient based on the acquired acceleration and wheel speed, and a correction unit that corrects the derived first road surface gradient based on the information regarding the power for driving the vehicle to derive a second road surface gradient.

According to the present disclosure, it is possible to provide a technology of preventing degradation of accuracy in deriving a gradient of a road surface on which a vehicle is traveling.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a functional configuration of a road surface gradient estimation system according to an embodiment;

FIG. 2 is a view for explaining a method for deriving a first road surface gradient;

FIG. 3 is a view for explaining correction processing of a road surface gradient according to the embodiment; and

FIG. 4 is a view for explaining correction processing of a road surface gradient according to a modification.

### DETAILED DESCRIPTION OF EMBODIMENTS

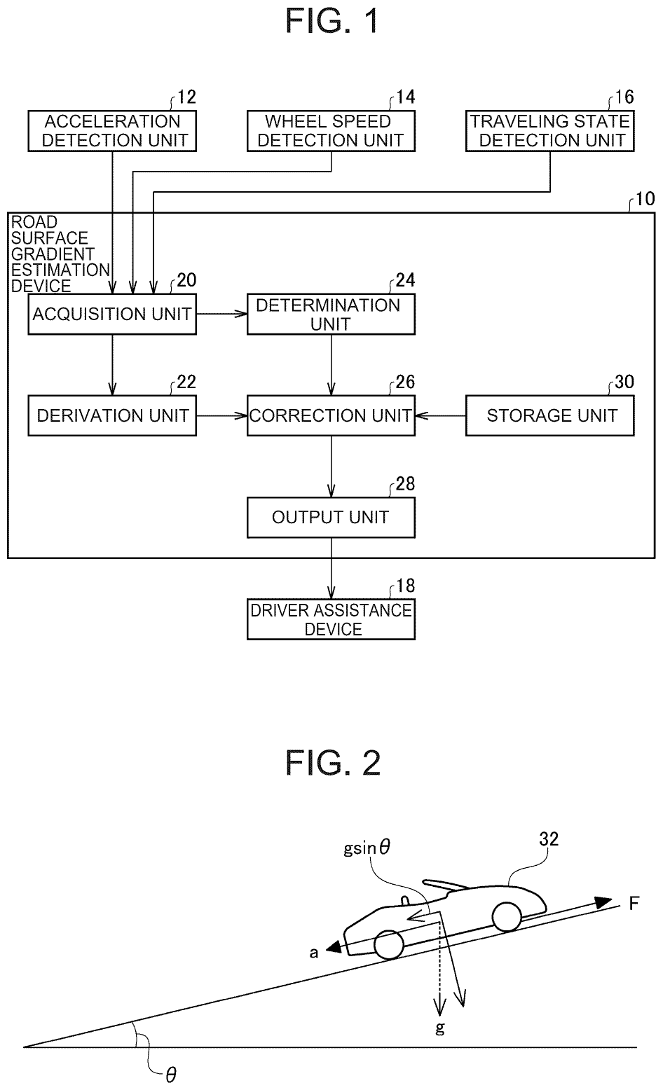

FIG. 1 is a view illustrating a functional configuration of a road surface gradient estimation system 1 according to an embodiment. The road surface gradient estimation system 1, which includes a road surface gradient estimation device 10, an acceleration detection unit 12, a wheel speed detection unit 14, a traveling state detection unit 16, and a driver assistance device 18, is mounted on a vehicle. The road surface gradient estimation device 10 acquires detection results of the acceleration detection unit 12, the wheel speed detection unit 14, and the traveling state detection unit 16, derives a gradient of a road surface on which the vehicle is traveling, and outputs the derived gradient of the road surface to the driver assistance device 18.

The acceleration detection unit 12 detects an acceleration in a vehicle front-rear direction and transmits the detection result to the road surface gradient estimation device 10. The wheel speed detection unit 14 detects a wheel speed that is a rotation speed of a wheel and transmits the detection result to the road surface gradient estimation device 10. The wheel speed detection unit 14 may be provided at each wheel and may output a wheel speed of one of the wheels as the wheel speed or may output an average value of wheel speeds of the respective wheels as the wheel speed.

The traveling state detection unit 16 detects a traveling state of the vehicle and transmits the detection result to the road surface gradient estimation device 10. Information regarding the traveling state of the vehicle includes an output value (that is, driving force) of an engine device, target driving force of the engine device, an output value (that is, driving force) of a brake device, target driving force of the brake device, a vehicle speed, friction force of a tire, a steering angle, and the like. The target driving force of the engine device and the target driving force of the brake device are command values. The output value of the engine device, the output value of the brake device, the vehicle speed, and the friction force of the tire are information regarding power for driving the vehicle.

The driver assistance device 18 has a function of assisting a driver in driving, and, for example, executes autonomous driving control such as cruise control and tracking control. The driver assistance device 18 receives road surface gradient information from the road surface gradient estimation device 10 and issues a command to output power in accordance with the gradient of the road surface during autonomous driving control.

The road surface gradient estimation device 10 includes an acquisition unit 20, a derivation unit 22, a determination unit 24, a correction unit 26, an output unit 28, and a storage unit 30. The acquisition unit 20 acquires each of detection results of an acceleration detection unit that detects an acceleration in the vehicle front-rear direction, and a wheel speed detection unit, and acquires information regarding power for driving the vehicle. The acquisition unit 20 acquires traveling state information indicating the traveling state of the vehicle.

The derivation unit 22 derives a gradient of the road surface on which the vehicle is traveling as a first road surface gradient based on the acceleration in the vehicle front-rear direction and the wheel speed. Here, FIG. 2 is referred to. FIG. 2 is a view for explaining a method for deriving the first road surface gradient.

In FIG. 2, a vehicle 32 is traveling on a road surface with a road surface gradient θ. The vehicle 32 is traveling with vehicle driving force F and receives a gradient acceleration (g·sin θ) from the road surface. The vehicle 32 is traveling at an acceleration a calculated by a differential value of the wheel speed.

An acceleration (a+g·sin θ) to be applied to the vehicle 32 is estimated to be equal to an acceleration a′ detected by the acceleration detection unit 12. The derivation unit 22 estimates the gradient acceleration (g·sin θ) by the following equation 1 based on the differential value a of the wheel speed, the acceleration a′ in the vehicle front-rear direction, and a gravitational acceleration g. The road surface gradient θ becomes a negative angle downslope and becomes a positive angle upslope. Note that while the road surface gradient θ may be set to be a positive angle downslope and to be a negative angle upslope, in which case, there is a portion where positive and negative signs are inverted in a portion of the road surface gradient θ included in the equation.

a′−a=g·sin θ Equation 1

Here, while the acceleration a′ detected by the acceleration detection unit 12 is used to derive the first road surface gradient, there is a possibility that an offset error, an error due to a temperature, or the like, may occur in a sensor value of the acceleration detection unit 12. Thus, the correction unit 26 corrects the derived first road surface gradient based on the information regarding the power for driving the vehicle to derive a second road surface gradient. The first road surface gradient and the second road surface gradient may be a gradient acceleration (g·sin θ) or may be an angle θ of the road surface.

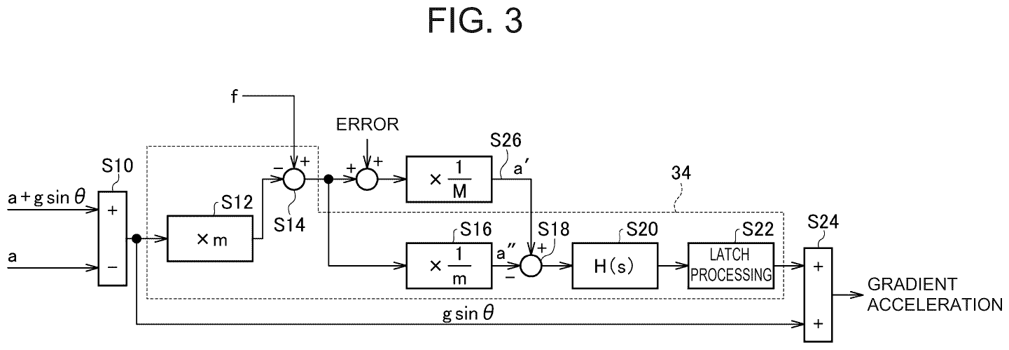

FIG. 3 is a view for explaining correction processing of the road surface gradient according to the embodiment. The derivation unit 22 estimates the gradient acceleration (g·sin θ) using equation 1 (S10). The derivation unit 22 multiplies the gradient acceleration (g·sin θ) by a vehicle weight m (S12) and adds vehicle driving force f (S14). In S14, force F to be applied to the whole vehicle is derived as indicated in the following equation 2.

−mg·sin θ+f=F Equation 2

m is the vehicle weight and stored in the storage unit 30 in advance. The vehicle weight m includes weights of occupants. The weights of the occupants may be a value set in advance. The vehicle driving force f is calculated by adding the output value of the engine device, the output value of the brake device, the friction force of the tire and resisting force of air. The resisting force of air is calculated in accordance with the vehicle speed. The output value of the engine device, the output value of the brake device and the friction force of the tire May be values detected by the traveling state detection unit 16 or may be received values calculated by driving control and brake control systems.

The correction unit 26 executes correction value derivation processing 34 enclosed with a dashed line. The correction unit 26 divides the force F to be applied to the whole vehicle by the vehicle weight m to estimate a traveling acceleration a″ (S16). The correction unit 26 derives a difference between the traveling acceleration a″ and the acceleration a′ detected by the acceleration detection unit 12 as a temporary correction value (S18). As a result of this, an error between the estimation value and the actual measured value is derived as the temporary correction value. The correction unit 26 transmits the temporary correction value in which H(s)=1 as is to the next step in S20.

The determination unit 24 determines whether the acquired traveling state information satisfies a predetermined stable traveling condition, and when the traveling state information does not satisfy the predetermined stable traveling condition, the correction unit 26 discards the temporary correction value and executes latch processing of setting a correction value used as the previous correction value, as a correction value of this time (S22). In the latch processing, when the traveling state information satisfies the predetermined stable traveling condition, the correction unit 26 sets the temporary correction value as the correction value of this time (S22). While the traveling state information does not satisfy the predetermined stable traveling condition, the correction unit 26 continues to perform correction with the same correction value. The previous correction value refers to a correction value in a cycle one cycle before a calculation cycle of this time.

The predetermined stable traveling condition is not satisfied when the vehicle 32 makes a hard stop, steers suddenly or stops. This is because the vehicle driving force f cannot be detected with high accuracy when the vehicle 32 is not stably traveling. For example, the predetermined stable traveling condition is satisfied when the change amount of the output value of the brake device is equal to or less than a predetermined amount, the change amount of the steering angle is equal to or less than a predetermined angle, and the vehicle speed is equal to or higher than a predetermined speed. Further, the predetermined stable traveling condition includes that a failure does not occur in the acceleration detection unit 12, and when a failure occurs in the acceleration detection unit 12, the predetermined stable traveling condition is not satisfied.

The correction unit 26 derives the corrected gradient acceleration by adding the gradient acceleration (g·sin θ) and the correction value of this time (S24). The correction unit 26 may output the corrected gradient acceleration as the second road surface gradient or may output an angle θ derived from the corrected gradient acceleration as the second road surface gradient. The correction unit 26 stores the correction value used in correction of this time in the storage unit 30. The output unit 28 transmits the derived second road surface gradient to the driver assistance device 18.

In this manner, the correction unit 26 calculates the correction value based on the information regarding power for driving the vehicle and corrects the derived first road surface gradient with the correction value to derive the second road surface gradient. This makes it possible to prevent degradation of accuracy in deriving the road surface gradient even if an offset error, or the like, occurs in the acceleration detection unit 12.

The correction unit 26 derives the correction value based on the estimated gradient acceleration (g·sin θ), the detected acceleration a′ in the vehicle front-rear direction, the vehicle weight m and the vehicle driving force f. The correction unit 26 estimates the traveling acceleration a″ based on the estimated gradient acceleration (g·sin θ) and the vehicle driving force f and derives the correction value based on the estimated traveling acceleration a″ and the acceleration a′ in the vehicle front-rear direction, which is an actual measured value. By this means, the correction value can be derived with high accuracy using a difference between the estimated traveling acceleration a″ and the acceleration a′ that is the actual measured value.

When the acquired traveling state information does not satisfy the predetermined stable traveling condition, the correction unit 26 corrects the first road surface gradient with the correction value used in the previous correction to derive the second road surface gradient. The previous correction value is stored in the storage unit 30 in the previous calculation cycle. By this means, correction is executed with the same correction value until the predetermined stable traveling condition is satisfied. As a result of the correction unit 26 performing correction with the previous correction value, it is possible to avoid correction with an unstable correction value. When an offset error of the acceleration detection unit 12 is constant, influence of the offset error can be reduced by the correction unit 26 performing correction with the previous correction value.

The vehicle weight M that is a true value indicated in S26 in FIG. 3 is used in theoretical calculation and is not used in actual calculation, because the actual measured value of the acceleration is used in the actual calculation.

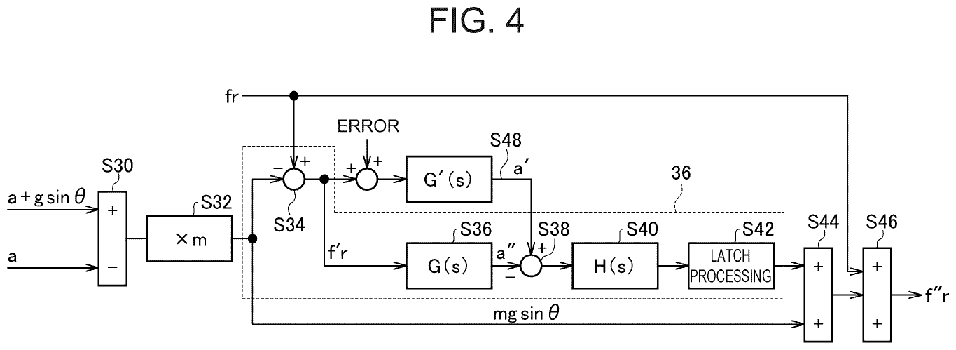

FIG. 4 is a view for explaining correction processing of a road surface gradient according to a modification. The correction unit 26 in the modification performs correction using transmission characteristics G(s) that are information regarding power for driving the vehicle. The storage unit 30 may store the transmission characteristics G(s) in advance, and the acquisition unit 20 acquires the transmission characteristics G(s) from the storage unit 30, or the like.

The transmission characteristics G(s) are a function indicating a relationship between the target driving force of the vehicle and the acceleration in the vehicle front-rear direction, which is an output result of the target driving force. In other words, the transmission characteristics G(s) receive inputs of the target driving force of the engine device and the target driving force of the brake device and output the acceleration in the vehicle front-rear direction. The target driving force of the engine device and the target driving force of the brake device are command values to the engine device and the brake device and are referred to as target driving force fr in driving of the vehicle. The target driving force of the engine device and the target driving force of the brake device may be acquired from the driver assistance device 18 that is performing autonomous driving control.

The derivation unit 22 estimates the gradient acceleration (g·sin θ) using equation 1 (S30). The derivation unit 22 derives gradient acting force (mg·sin θ) by multiplying the gradient acceleration (g·sin θ) by the vehicle weight m (S32).

The correction unit 26 executes correction value derivation processing 36 enclosed with a dashed line. The correction unit 26 subtracts the estimated gradient acting force (mg·sin θ) from the target driving force fr in driving of the vehicle to derive the target driving force fr′ in which influence of the road surface gradient is added (S34). The correction unit 26 estimates the traveling acceleration a″ by inputting the derived target driving force fr′ to the transmission characteristics G(s) (S36).

The correction unit 26 derives a difference between the acceleration a′ detected by the acceleration detection unit 12 and the traveling acceleration a″ (S38). By this means, an error between the actual measured value and the estimation value is derived. Note that a transmission function G′ (s) that is a true value indicated in S48 is used in theoretical calculation and is not used in actual calculation, because the actual measured value of the acceleration is used in the actual calculation.

The correction unit 26 substitutes the difference (a′−a″) derived in S38 as H(s)=G⁻¹(s) to derive the target output value as the temporary correction value (S40).

The determination unit 24 determines whether the acquired traveling state information satisfied the predetermined stable traveling condition, and when the traveling state information does not satisfy the predetermined stable traveling condition, the correction unit 26 discards the temporary correction value and executes latch processing of setting the correction value used as the previous correction value, as the correction value of this time (S42). In the latch processing, when the predetermined stable traveling condition is satisfied, the correction unit 26 sets the temporary correction value as the correction value of this time (S42). The correction unit 26 stores the correction value of this time in the storage unit 30.

The correction unit 26 drives a target output value fr″ by performing correction by adding the estimated gradient acting force (mg·sin θ) and the correction value of this time (S44) and further adding the target output value fr (S46). The output unit 28 outputs the corrected target output value fr″ to the driver assistance device 18, and the driver assistance device 18 controls the engine device and the brake device with the target output value fr″.

The present disclosure has been described above based on the embodiment. The present disclosure is not limited to the above-described embodiment, various modifications such as design changes can be made based on the knowledge of a person skilled in the art.

What is claimed is:

1. A road surface gradient estimation device comprising:
an acquisition unit that acquires each of detection results of an acceleration detection unit that detects an acceleration in a front-rear direction of a vehicle, and a wheel speed detection unit, and acquires information regarding power for driving the vehicle;
a derivation unit that derives a gradient of a road surface on which the vehicle is traveling as a first road surface gradient based on the acquired acceleration and wheel speed; and
a correction unit that corrects the derived first road surface gradient based on the information regarding the power for driving the vehicle to derive a second road surface gradient.

2. The road surface gradient estimation device according to claim 1, wherein:
the acquisition unit acquires traveling state information indicating a traveling state of the vehicle;
the correction unit calculates a correction value based on the information regarding the power for driving the vehicle and corrects the derived first road surface gradient with the correction value to derive the second road surface gradient; and
when the acquired traveling state information does not satisfy a predetermined stable traveling condition, the correction unit corrects the first road surface gradient with a correction value used in previous correction to derive the second road surface gradient.

3. The road surface gradient estimation device according to claim 1, wherein:
the acquisition unit acquires the information regarding the power for driving the vehicle;
the derivation unit estimates a gradient acceleration caused in the vehicle by the gradient of the road surface based on the acquired acceleration and wheel speed; and
the correction unit drives a correction value based on the estimated gradient acceleration, the detected acceleration in the front-rear direction of the vehicle, a vehicle weight and vehicle driving force.

4. The road surface gradient estimation device according to claim 3, wherein the correction unit estimates a traveling acceleration based on the gradient acceleration and the vehicle driving force and derives the correction value based on a difference between the estimated traveling acceleration and the detection value of the acceleration in the front-rear direction of the vehicle.

5. The road surface gradient estimation device according to claim 1, wherein:
the acquisition unit acquires target driving force input to the vehicle, and transmission characteristics indicating a relationship between the target driving force and the detected acceleration in the front-rear direction of the vehicle;
the derivation unit derives a gradient acceleration to be applied to the vehicle by the gradient of the road surface; and
the correction unit derives the correction value based on the derived gradient acceleration, a vehicle weight, the target driving force of the vehicle, the transmission characteristics, and the detected acceleration in the front-rear direction of the vehicle.
